(19) United States
(12) Patent Application Publication
(10) Pub. No.: US 2025/0048417 A1
(43) Pub. Date: Feb. 6, 2025

(54) METHOD, DEVICE AND COMPUTER READABLE MEDIUM FOR COMMUNICATIONS

(71) Applicant: NEC CORPORATION, Tokyo (JP)

(72) Inventors: Zhaobang MIAO, Beijing (CN); Gang WANG, Beijing (CN)

(73) Assignee: NEC CORPORATION, Tokyo (JP)

(21) Appl. No.: 18/717,736

(22) PCT Filed: Dec. 9, 2021
(86) PCT No.: PCT/CN2021/136858

§ 371 Date: Jun. 7, 2024

(51) Int. Cl. H04W 72/566; H04W 52/36; H04W 72/40

(52) U.S. Cl. CPC H04W 72/566; H04W 52/367; H04W 72/40

(57) ABSTRACT

Embodiments of the present disclosure relate to method, device and computer readable media for communications. A method comprises comparing at least one of priority values for a first plurality of sidelink transmissions on a first carrier with a priority threshold and determining, at a terminal device, a first priority value associated with a first carrier as one of the following based on the comparing: an average value of priority values for the first plurality of sidelink transmissions on the first carrier, a median value of the priority values, or one of the priority values. The method also comprises comparing the first priority value with a second priority value associated with a second carrier, at least one second sidelink transmission on the second carrier overlapping in time with the first plurality of sidelink transmissions. The method also comprises adjusting transmission power of the first plurality of sidelink transmissions or the at least one second sidelink transmission based on the comparison.

### TECHNICAL FIELD

Embodiments of the present disclosure generally relate to the field of telecommunication, and in particular, to a method, device and computer readable media for sidelink communication.

### BACKGROUND

Multiple carriers operation for New Radio (NR) sidelink will be one of the objectives in Release 18. If one or more sidelink transmissions of a terminal device on a carrier overlap in time with one or more sidelink transmissions on other carriers and its total transmission power exceeds a max transmission power limit, the terminal device shall adjust the transmission power of the sidelink transmissions on one of the carriers such that its total transmission power does not exceed the max transmission power limit.

### SUMMARY

In general, example embodiments of the present disclosure provide methods, devices and computer readable media for communications.

In a first aspect, there is provided a method for communications. The method comprises comparing, at a terminal device, at least one of priority values for a first plurality of sidelink transmissions on a first carrier with a priority threshold. The method also comprises determining a first priority value associated with the first carrier as one of the following: an average value of priority values for the first plurality of sidelink transmissions on the first carrier, a median value of the priority values, or one of the priority values. The method also comprises comparing the first priority value with a second priority value associated with a second carrier, at least one second sidelink transmission on the second carrier overlapping in time with the first plurality of sidelink transmissions. The method also comprises adjusting transmission power of the first plurality of sidelink transmissions or the at least one second sidelink transmission based on the comparison.

In a second aspect, there is provided a terminal device. The terminal device comprises a processor and a memory storing instructions. The memory and the instructions are configured, with the processor, to cause the terminal device to perform the method according to the first aspect.

In a third aspect, there is provided a computer readable medium having instructions stored thereon. The instructions, when executed on at least one processor of a device, cause the device to perform the method according to the first aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates an example communication network in which implementations of the present disclosure can be implemented;

FIG. 2 illustrates a flowchart of an example method in accordance with some embodiments of the present disclosure:

FIGS. 3A and 3B illustrate a flowchart of an example method in accordance with some other embodiments of the present disclosure, respectively:

FIG. 4 illustrates an example where a sidelink transmission on a carrier overlaps in time with sidelink transmissions on other carriers in accordance with some embodiments of the present disclosure; and

FIG. 5 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below:

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability: It generally includes a model which has been trained from numerous collected data for a specific function, and can be used to predict some information.

The terminal or the network device may work on several frequency ranges, e.g. FRI (410 MHZ-7125 MHZ), FR2 (24.25 GHz to 71 GHZ), frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘some embodiments’ and ‘an embodiment’ are to be read as ‘at least some embodiments.’ The term ‘another embodiment’ is to be read as ‘at least one other embodiment.’ The terms ‘first,’ ‘second,’ and the like may refer to different or same objects. Other definitions, explicit and implicit, may be included below:

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

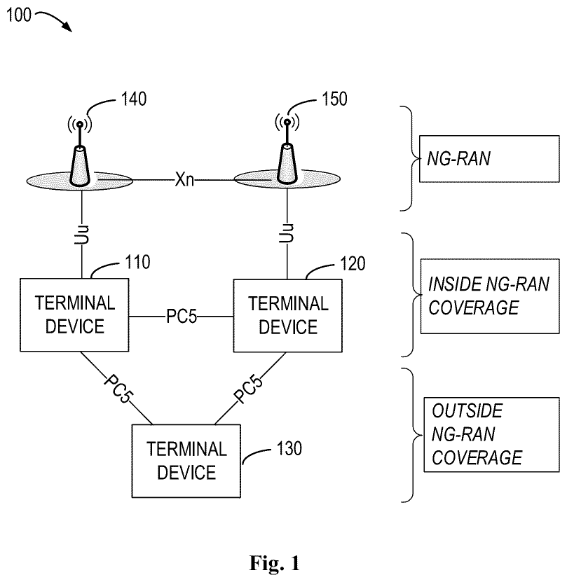

FIG. 1 illustrates a schematic diagram of an example communication network 100 in which embodiments of the present disclosure can be implemented. As shown in FIG. 1, the communication network 100 may include a terminal device 110, a terminal device 120, a terminal device 130, network devices 140 and 150. The network devices 140 and 150 may communicate with the terminal device 110, the terminal device 120 and the terminal device 130 via respective wireless communication channels.

In some embodiments, the network device 140 may be a gNB in NR, and the network device 150 may be an eNB in Long Term Evolution (LTE) system.

It is to be understood that the number of devices in FIG. 1 is given for the purpose of illustration without suggesting any limitations to the present disclosure. The communication network 100 may include any suitable number of network devices and/or terminal devices adapted for implementing implementations of the present disclosure.

The communications in the communication network 100 may conform to any suitable standards including, but not limited to, Global System for Mobile Communications (GSM), LTE, LTE-Evolution, LTE-Advanced (LTE-A), Wideband Code Division Multiple Access (WCDMA), Code Division Multiple Access (CDMA), GSM EDGE Radio Access Network (GERAN), Machine Type Communication (MTC) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

In some embodiments, the communications in the communication network 100 may comprise sidelink communication. Sidelink communication is a wireless radio communication directly between two or more terminal devices, such as two or more terminal devices among the terminal device 110, the terminal device 120 and the terminal device 130. In this type of communication, the two or more terminal devices that are geographically proximate to each other can directly communicate without going through the network device 140 or 150 or through a core network. Data transmission in sidelink communication is thus different from typical cellular network communications, in which a terminal device transmits data to the network device 140 or 150 (i.e., uplink transmissions) or receives data from the network device 140 or 150 (i.e., downlink transmissions). In sidelink communication, data is transmitted directly from a source terminal device (such as the terminal device 110) to a target terminal device (such as the terminal device 120) through the Unified Air Interface, e.g., PC5 interface, (i.e., sidelink transmissions), as shown in FIG. 1.

Sidelink communication can provide several advantages, including reducing data transmission load on a core network, system resource consumption, transmission power consumption, and network operation costs, saving wireless spectrum resources, and increasing spectrum efficiency of a cellular wireless communication system.

In a sidelink communication system, the sidelink resource is used to transmit information between terminal devices. According to application scenarios, service types, etc., a sidelink communication manner includes but is not limited to device to device (D2D) communication, Vehicle-to-Everything (V2X) communication, etc.

V2X communication enables vehicles to communicate with other vehicles (i.e. Vehicle-to-Vehicle (V2V) communication), with infrastructure (i.e. Vehicle-to-Infrastructure (V2I), with wireless networks (i.e. Vehicle-to-Network (V2N) communication), with pedestrians (i.e. Vehicle-to-Pedestrian (V2P) communication), and even with the owner's home (i.e. Vehicle-to-Home (V2H)). Examples of infrastructure include roadside units such as traffic lights, toll gates and the like. V2X communication can be used in a wide range of scenarios, including in accident prevention and safety, convenience, traffic efficiency and clean driving, and ultimately in relation to autonomous or self-driving vehicles.

For sidelink communications, a terminal device uses resources in sidelink resource pools to transmit or receive signals. The sidelink resource pools include resources in time domain and frequency domain, which are dedicated resources of the sidelink communication, or shared by the sidelink communication and a cellular link.

The terminal device 110, the terminal device 120 and the terminal device 130 may use sidelink channels to transmit sidelink signaling or information. The sidelink channels include at least one of the following: a Physical Sidelink Control Channel (PSCCH) resource which is used for carrying sidelink control information (SCI), a Physical Sidelink Shared Channel (PSSCH) resource which is used for carrying sidelink data service information, a physical sidelink feedback channel (PSFCH) resource which is used for carrying sidelink ACK/NACK feedback information, a physical sidelink broadcast channel (PSBCH) resource which is used for carrying sidelink broadcast information, and a physical sidelink discovery channel (PSDCH) resource which is used for carrying a sidelink discovery signal.

In LTE, a terminal device may perform a procedure related to sidelink as below:

In sidelink transmission mode 3 or 4, if a sidelink transmission of the terminal device on a carrier overlaps in time with sidelink transmission on other carrier(s) and its total transmission power exceeds a max transmission power limit P_{CMAX}, the terminal device shall adjust the transmission power of the sidelink transmission which has SCI whose “Priority” field is set to the largest value among all the “Priority” values of the overlapped sidelink transmissions such that its total transmission power does not exceed the max transmission power limit P_{CMAX}. If the transmission power still exceeds the max transmission power limit P_{CMAX} after this power adjustment, the terminal device shall drop the sidelink transmission with the largest “Priority” field in its SCI and repeat this procedure over the non-dropped carriers.

However, in Release 18, there will be multiple sidelink transmissions in one slot on one carrier and there will be different SCS between carriers. It is not clear which transmission's priority is used for comparison.

Embodiments of the present disclosure provide a solution for sidelink transmission so as to solve the above problems and one or more of other potential problems. According to the solution, a terminal device determines a first priority value associated with a first carrier as one of the following: an average value of priority values for a first plurality of sidelink transmissions on the first carrier, a median value of the priority values, or one of the priority values. Then, the terminal device compares the first priority value with a second priority value associated with a second carrier, at least one second sidelink transmission on the second carrier overlapping in time with the first plurality of sidelink transmissions. In turn, the terminal device adjusts transmission power of the first plurality of sidelink transmissions or the at least one second sidelink transmission based on the comparison. In this way, traffics with higher priority may be protected in a more fair way.

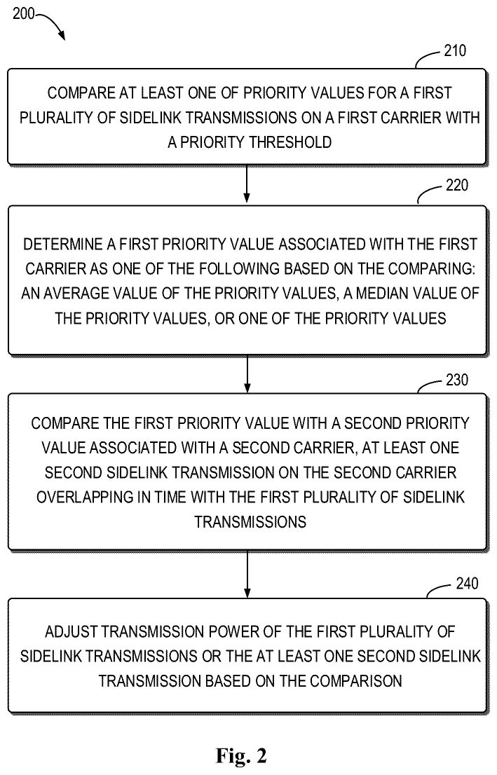

FIG. 2 illustrates a flowchart of an example method 200 in accordance with some embodiments of the present disclosure. In some embodiments, the method 200 can be implemented at a terminal device, such as one of the terminal device 110, the terminal device 120 and the terminal device 130 as shown in FIG. 1. For the purpose of discussion, the method 200 will be described with reference to FIG. 1 as performed by the terminal device 110 without loss of generality.

At block 210, the terminal device 110 compares at least one of priority values for a first plurality of sidelink transmissions on a first carrier with a priority threshold.

At block 220, the terminal device 110 determines, based on the comparing, a first priority value associated with a first carrier as one of the following: an average value of priority values for the first plurality of sidelink transmissions on the first carrier, a median value of the priority values, or one of the priority values.

At block 230, the terminal device 110 compares the first priority value with a second priority value associated with a second carrier. At least one second sidelink transmission on the second carrier overlaps in time with the first plurality of sidelink transmissions.

At block 240, the terminal device 110 adjusts transmission power of the first plurality of sidelink transmissions or the at least one second sidelink transmission based on the comparison.

With the method 200, traffics with higher priority may be protected in a more fair way: For example, Ultra Reliable Low Latency Communication (URLLC) traffic may be protected in a more fair way.

In some embodiments, the terminal device 110 may receive configuration information about the first priority value. For example, the terminal device 110 may receive the configuration information from the network device 140. The configuration information indicates that the first priority value is to be determined as the average value, the median value, or one of the priority values. In turn, the terminal device 110 may determine the first priority value based on the configuration information.

In some embodiments, the one of the priority values for the first plurality of sidelink transmissions comprises: a smallest value among the priority values, or a largest value among the priority values.

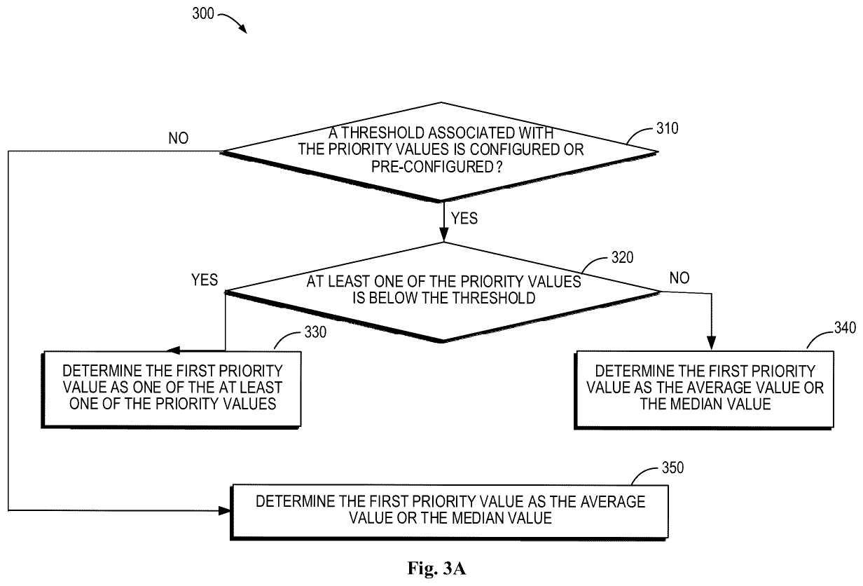

FIG. 3A illustrates a flowchart of an example method 300 in accordance with some embodiments of the present disclosure. The method 300 may be considered as an example implementation of the method 200. In some embodiments, the method 300 can be implemented at a terminal device, such as one of the terminal device 110, the terminal device 120 and the terminal device 130 as shown in FIG. 1. For the purpose of discussion, the method 300 will be described with reference to FIG. 1 as performed by the terminal device 110 without loss of generality.

At block 310, the terminal device 110 determines whether a priority threshold associated with the priority values is configured or pre-configured.

If the priority threshold associated with the priority values is configured or pre-configured, the terminal device 110 determines, at block 320, whether at least one of the priority values for the first plurality of sidelink transmissions on the first carrier is below the priority threshold.

If the at least one of the priority values for the first plurality of sidelink transmissions is below the priority threshold, the terminal device 110 determines, at block 330, the first priority value as one of the at least one of the priority values.

In some embodiments, the one of the at least one of the priority values may be a smallest value among the priority values. Alternatively, the one of the at least one of the priority values may be a priority value for an earliest sidelink transmission among a subset of the first plurality of sidelink transmissions. Priority values for sidelink transmissions in the subset are below the priority threshold. The subset may comprise all or part of the first plurality of sidelink transmissions.

If all the priority values for the first plurality of sidelink transmissions are equal to or greater than the priority threshold, the terminal device 110 determines, at block 340, the first priority value as the average value of the priority values or the median value of the priority values.

On the other hand, if the terminal device 110 determines, at block 310, that the priority threshold associated with the priority values is not configured or pre-configured, the terminal device 110 determines, at block 350, the first priority value as the average value of the priority values or the median value of the priority values.

FIG. 3B illustrates a flowchart of an example method 305 in accordance with some embodiments of the present disclosure. The method 305 may be considered as another example implementation of the method 200. In some embodiments, the method 305 can be implemented at a terminal device, such as one of the terminal device 110, the terminal device 120 and the terminal device 130 as shown in FIG. 1. For the purpose of discussion, the method 305 will be described with reference to FIG. 1 as performed by the terminal device 110 without loss of generality.

The method 305 is similar to the method 300 at blocks 310, 340 and 350. The method 305 is different from the method 300 in that if the priority threshold associated with the priority values is configured or pre-configured, the terminal device 110 determines, at block 325, whether the smallest value among the priority values for the first plurality of sidelink transmissions is below the priority threshold.

If the smallest value is below the priority threshold, the terminal device 110 determines, at block 335, the first priority value as the smallest value.

If the smallest value is not below the priority threshold, meaning that all the priority values for the first plurality of sidelink transmissions are equal to or greater than the priority threshold, the terminal device 110 determines, at block 340, the first priority value as the average value of the priority values or the median value of the priority values.

In some embodiments, the smaller a priority value for a sidelink transmission is, the higher a priority of the sidelink transmission is.

In some embodiments, in order to determine the first priority value as the average value of the priority values or the median value of the priority values, a ceil operation represented by ┌·┐ or a floor operation represented by └·┘ may be used.

In some embodiments, the priority threshold may be configured via a radio resource control (RRC) signaling.

In some embodiments, the priority threshold may be an integer in the range of 2 to 9. For example, the priority threshold may be one of 2, 3, 4, and 5.

In some embodiments, if the priority threshold not configured, the terminal device 110 may determine the priority threshold as a default priority threshold. For example, the terminal device 110 may determine the priority threshold as 2.

In some embodiments, the priority threshold may be specific to the terminal device 110 and a single value of the priority threshold may be configured or pre-configured for the first carrier and the second carrier.

It should be understood that the embodiments of the present disclosure have been described with reference to the determination of the first priority value associated with the first carrier by way of example. The terminal device 110 may perform a method similar to any of the methods 200, 300 and 305 to determine the second priority value associated with the second carrier.

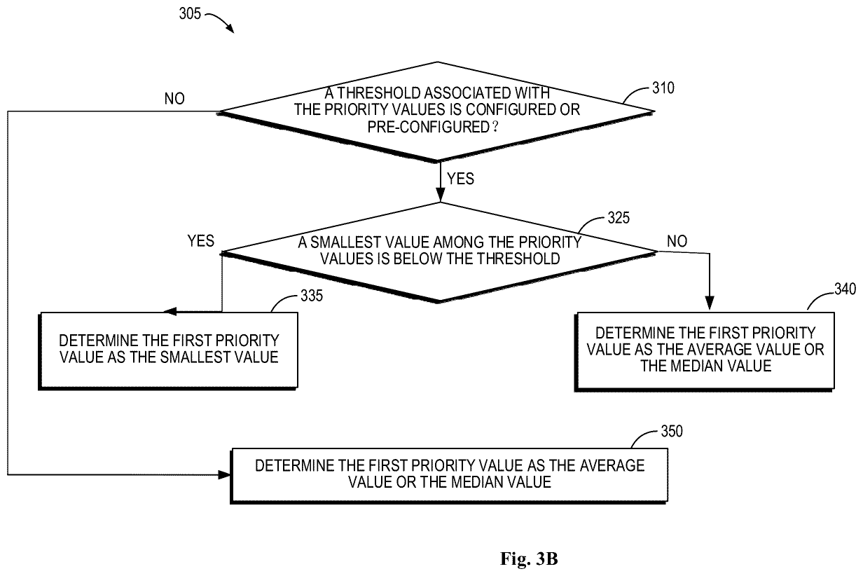

FIG. 4 illustrates an example 400 where a sidelink transmission on a carrier overlaps in time with sidelink transmissions on other carriers in accordance with some embodiments of the present disclosure.

In the example 400, the terminal device 110 performs four sidelink transmissions on a first carrier in four slots. The first carrier is represented by C2 in FIG. 4 and may have a sub-carrier space (SCS) of 60 KHz. The four sidelink transmissions are represented in FIG. 4 by SL 4, SL 5, SL 6 and SL 7, respectively.

In addition, the terminal device 110 performs two sidelink transmissions on a second carrier in two slots. The second carrier is represented by C1 in FIG. 4 and may have an SCS of 30 KHz. The two sidelink transmissions are represented in FIG. 4 by SL 2 and SL 3, respectively.

Furthermore, the terminal device 110 performs two sidelink transmissions on a third carrier in two slots. The third carrier is represented by C0 in FIG. 4 and may have an SCS of 15 KHz. The two sidelink transmissions are represented in FIG. 4 by SL 0 and SL 1, respectively. For example, the SL 0 may comprise a sidelink transmission on PSCCH or PSSCH, and the SL 1 may comprise a sidelink transmission on PSFCH.

In order to determine a first priority value associated with the carrier C2, the terminal device 110 may perform the method 300 or 305 described above.

In embodiments where the method 300 is performed, if a priority threshold associated with priority values for SL 4, SL 5, SL 6 and SL 7 on the carrier C2 is configured or pre-configured, the terminal device 110 determines whether at least one of the priority values for SL 4, SL 5, SL 6 and SL 7 is below the priority threshold.

If the at least one of the priority values for SL 4, SL 5, SL 6 and SL 7 is below the priority threshold, the terminal device 110 determines the first priority value associated with the carrier C2 as one of the at least one of the priority values.

In some embodiments, the one of the at least one of the priority values may be a smallest value among the priority values for SL 4, SL 5, SL 6 and SL 7. Alternatively, the one of the at least one of the priority values for SL 4, SL 5, SL 6 and SL 7 may be a priority value for an earliest sidelink transmission among a subset of the first plurality of sidelink transmissions, priority values for sidelink transmissions in the subset being below the priority threshold. For example, the first plurality of sidelink transmissions may comprise SL 4, SL 5, SL 6 and SL 7 and a subset of the first plurality of sidelink transmissions may comprise SL 5, SL 6 and SL 7. Priority values for SL 5, SL 6 and SL 7 are below the priority threshold. Because SL 5 is the earliest sidelink transmission among SL 5, SL 6 and SL 7, the terminal device 110 may determine the first priority value associated with the carrier C2 as a priority value for SL 5.

In embodiments where the method 305 is performed, if the priority threshold associated with priority values for SL 4, SL 5, SL 6 and SL 7 on the carrier C2 is configured or pre-configured, the terminal device 110 determines whether a smallest value among the priority values for SL 4, SL 5, SL 6 and SL 7 is below the priority threshold.

If the smallest value among the priority values for SL 4, SL 5, SL 6 and SL 7 is below the priority threshold, the terminal device 110 determines the first priority value associated with the carrier C2 as the smallest value.

If all the priority values for SL 4, SL 5, SL 6 and SL 7 are equal to or greater than the priority threshold, the terminal device 110 determines the first priority value as the average value of the priority values for SL 4, SL 5, SL 6 and SL 7 or the median value of the priority values for SL 4, SL 5, SL 6 and SL 7.

On the other hand, if the terminal device 110 determines that the priority threshold is not configured or pre-configured, the terminal device 110 determines the first priority value as the average value of the priority values for SL 4, SL 5, SL 6 and SL 7 or the median value of the priority values for SL 4, SL 5, SL 6 and SL 7.

Similarly, the terminal device 110 may determine the second priority value associated with the carrier C1 and a third priority value associated with the third carrier C0.

In turn, the terminal device 110 may compare the first priority value with the second and third priority values. If the first priority value is greater than the second and third priority values, the terminal device 110 may adjust transmission power of SL 4, SL 5, SL 6 and SL 7 such that its total transmission power does not exceed max transmission power limit. If the transmission power still exceeds a max transmission power limit after this power adjustment, the terminal device 110 may drop SL 4, SL 5, SL 6 and SL 7 and repeat this procedure over the carrier C1 and the carrier C0.

In some embodiments, the first plurality of sidelink transmissions may comprise all sidelink transmissions on the first carrier within an overlapped duration between the first carrier and the second carrier. For example, in the example 400 in FIG. 4, the first plurality of sidelink transmissions may comprise SL 4, SL 5, SL 6 and SL 7.

In some embodiments, the first plurality of sidelink transmissions may comprise part of sidelink transmissions on the first carrier within an overlapped duration between the first carrier and the second carrier. In such embodiments, the terminal device 110 determines priority values for the part of sidelink transmissions before determining the first priority value. In other words, the part of sidelink transmissions on the first carrier within the overlapped duration is known at the terminal device 110 at an offset time before the earliest transmission subject to processing time of the terminal device 110.

In some embodiments, if the solution of the present disclosure is accepted by the 3GPP, the following revision may be made in 3GPP specification.

In sidelink transmission mode 1 or 2, if one or more UE's sidelink transmissions on a carrier overlaps in time with one or more sidelink transmissions on other carrier(s) and its total transmission power exceeds max transmission power limit, the UE shall adjust the transmission power of the sidelink transmissions in the carrier whose P_carrier (where P_carrier represents a priority associated with the carrier) is the largest among all the overlapped sidelink carriers such that its total transmission power does not exceed max transmission power limit. In this case, calculation of the adjustment to the sidelink transmission power is not specified. If the transmission power still exceeds max transmission power limit after this power adjustment, the UE shall drop the sidelink transmissions in the carrier whose P_carrier is the largest and repeat this procedure over the non-dropped carriers. It is not specified which sidelink carrier the UE adjusts when multiple sidelink carriers have the same P_carrier value.

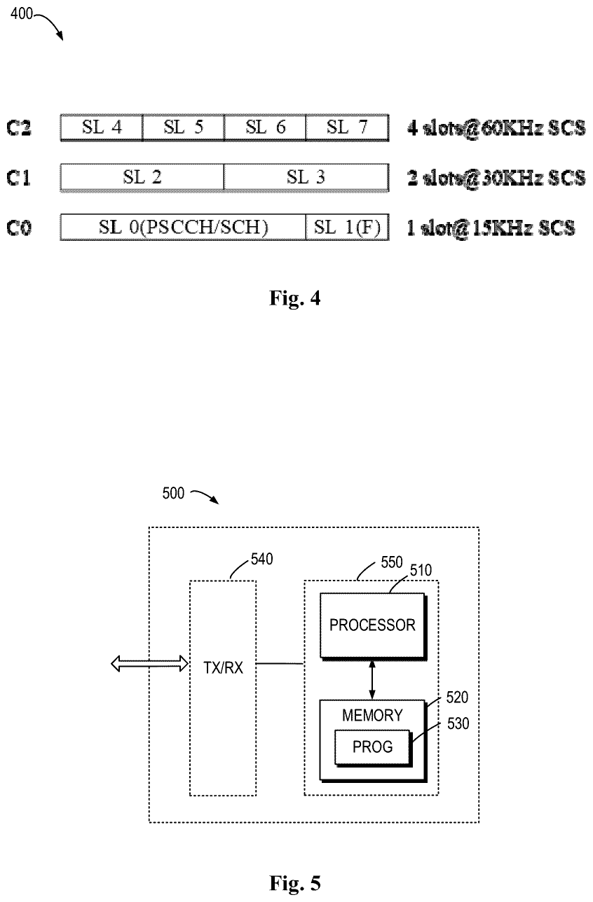

FIG. 5 is a simplified block diagram of a device 500 that is suitable for implementing some embodiments of the present disclosure. The device 500 can be considered as a further example embodiment of the terminal device 110 as shown in FIG. 1. Accordingly, the device 500 can be implemented at or as at least a part of the terminal device 110.

As shown, the device 500 includes a processor 510, a memory 520 coupled to the processor 510, a suitable transmitter (TX) and receiver (RX) 540 coupled to the processor 510, and a communication interface coupled to the TX/RX 540. The memory 520 stores at least a part of a program 530. The TX/RX 540 is for bidirectional communications. The TX/RX 540 has at least one antenna to facilitate communication, though in practice an Access Node mentioned in this application may have several ones. The communication interface may represent any interface that is necessary for communication with other network elements, such as X2 interface for bidirectional communications between gNBs or eNBs, S1 interface for communication between a Mobility Management Entity (MME)/Serving Gateway (S-GW) and the gNB or eNB, Un interface for communication between the gNB or eNB and a relay node (RN), or Uu interface for communication between the gNB or eNB and a terminal device.

The program 530 is assumed to include program instructions that, when executed by the associated processor 510, enable the device 500 to operate in accordance with the embodiments of the present disclosure, as discussed herein with reference to FIGS. 1 to 4. The embodiments herein may be implemented by computer software executable by the processor 510 of the device 500, or by hardware, or by a combination of software and hardware. The processor 510 may be configured to implement various embodiments of the present disclosure. Furthermore, a combination of the processor 510 and memory 520 may form processing means 550 adapted to implement various embodiments of the present disclosure.

The memory 520 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 520 is shown in the device 500, there may be several physically distinct memory modules in the device 500. The processor 510 may be of any type suitable to the local technical network, and may include one or more of general purpose computers, special purpose computers, microprocessors, digital signal processors (DSPs) and processors based on multicore processor architecture, as non-limiting examples. The device 500 may have multiple processors, such as an application specific integrated circuit chip that is slaved in time to a clock which synchronizes the main processor.

The components included in the apparatuses and/or devices of the present disclosure may be implemented in various manners, including software, hardware, firmware, or any combination thereof. In one embodiment, one or more units may be implemented using software and/or firmware, for example, machine-executable instructions stored on the storage medium. In addition to or instead of machine-executable instructions, parts or all of the units in the apparatuses and/or devices may be implemented, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to any of FIGS. 1 to 4. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific embodiment details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A method for communications, comprising:
comparing, at a terminal device, at least one of priority values for a first plurality of sidelink transmissions on a first carrier with a priority threshold;
determining a first priority value associated with the first carrier as one of the following based on the comparing:
an average value of the priority values,
a median value of the priority values, or
one of the priority values:
comparing the first priority value with a second priority value associated with a second carrier, at least one second sidelink transmission on the second carrier overlapping in time with the first plurality of sidelink transmissions; and
adjusting transmission power of the first plurality of sidelink transmissions or the at least one second sidelink transmission based on the comparison.

2. The method of claim 1, wherein determining the first priority value as one of the priority values comprises:
if the at least one of the priority values is below the priority threshold, determining the first priority value as one of the at least one of the priority values.

3. The method of claim 2, wherein the one of the at least one priority value comprises:
a smallest value among the priority values, or
a priority value for an earliest sidelink transmission among a subset of the first plurality of sidelink transmissions, priority values for sidelink transmissions in the subset being below the priority threshold.

4. The method of claim 1, wherein determining the first priority value as one of the priority values comprises:
if a smallest value among the priority values is below the priority threshold, determining the first priority value as the smallest value.

5. The method of claim 1, wherein determining the first priority value as the average value or the median value comprises:
if all the priority values are equal to or greater than the priority threshold, determining the first priority value as the average value or the median value.

6. The method of any of claims 2 to 5, further comprising:
if the priority threshold is not configured, determining the priority threshold as a default priority threshold.

7. The method of claim 1, wherein determining the first priority value as the average value or the median value comprises:
if a priority threshold associated with the priority values is not configured or pre-configured, determining the first priority value as the average value or the median value.

8. The method of claim 1, wherein determining the first priority value comprises:
receiving configuration information about the first priority value, the configuration information indicating that the first priority value is to be determined as the average value, the median value, or one of the priority values; and
determining the first priority value based on the configuration information.

9. The method of claim 1, wherein the first plurality of sidelink transmissions comprise:
all sidelink transmissions on the first carrier within an overlapped duration between the first carrier and the second carrier.

10. The method of claim 1, wherein the first plurality of sidelink transmissions comprise:
part of sidelink transmissions on the first carrier within an overlapped duration between the first carrier and the second carrier; and
the method further comprises:
determining priority values for the part of sidelink transmissions before determining the first priority value.

11. A terminal device, comprising:
a processor, and
a memory coupled to the processor and storing instructions thereon, the instructions, when executed by the processor, causing the terminal device to perform the method according to any of claims 1-10.

12. A computer readable medium having instructions stored thereon, the instructions, when executed on at least one processor of a device, causing the device to carry out the method according to any of claims 1-10.
